(19) United States
(12) Patent Application Publication
(10) Pub. No.: US 2026/0352635 A1
(43) Pub. Date: Nov. 5, 2026

(54) INLINE DNS ASSURED FORWARDING (DAF)

(71) Applicant: Infoblox Inc., Santa Clara, CA (US)

(72) Inventors: Adam Alexander Casella, San Jose, CA (US); Sagar Guntaka, Santa Clara, CA (US); Glenn Alan Sullivan, San Jose, CA (US)

(21) Appl. No.: 19/299,203

(22) Filed: Aug. 13, 2025

Related U.S. Application Data
(60) Provisional application No. 63/797,710, filed on Apr. 30, 2025.

(51) Int. Cl. H04L 9/40; H04L 61/4511

(52) U.S. Cl. CPC H04L 63/0263; H04L 63/306; H04L 61/4511

(57) ABSTRACT

Various techniques for providing DNS assured forwarding (DAF) are disclosed. In some embodiments, a system, a process, and/or a computer program product for dynamically programming a network data plane based on DNS responses embodied in a non-transitory computer readable medium and comprising computer instructions includes: intercepting a DNS query and a DNS response using a DNS intercept and inspection module; analyzing DNS packets based on a DNS policy or a Response Policy Zone (RPZ) policy using a DNS inspection module; redirecting DNS traffic from an untrusted DNS server to a trusted DNS server using a DNS traffic redirection module; and enforcing a network access policy in the network data plane using a network access policy programming module.

### CROSS REFERENCE TO OTHER APPLICATIONS

This application claims priority to U.S. Provisional Patent Application No. 63/797,710 entitled INLINE DNS ASSURED FORWARDING (DAF) filed Apr. 30, 2025, which is incorporated herein by reference for all purposes.

### BACKGROUND OF THE INVENTION

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names). Web addresses are translated into IP addresses. The Domain Name System (DNS) is responsible for performing this translation from web addresses into IP addresses. Specifically, requests including web addresses are sent to DNS servers that generally reply with corresponding IP addresses or with an error message in case the domain has not been registered, a non-existent domain.

### BRIEF DESCRIPTION OF THE DRAWINGS

Various embodiments of the invention are disclosed in the following detailed description and the accompanying drawings.

FIG. 1 is a block diagram of a DNS Assured Forwarding (DAF) system in accordance with some embodiments.

FIGS. 2A-2R are screen diagrams of graphical user interfaces of the DAF system in accordance with some embodiments.

FIG. 3 is a flow diagram of a DAF process in accordance with some embodiments.

FIG. 4 is another flow diagram of a DAF process in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The increasing reliance on DNS for network security necessitates robust mechanisms to enforce DNS policies (e.g., DNS security policies) beyond DNS itself. Traditional methods often require manual configuration of security policies on network data planes, which can be cumbersome and error prone.

As such, there exists a need for improved mechanisms for enforcing DNS policies.

### Overview of Techniques for DNS Assured Forwarding (DAF)

Various techniques for providing DNS assured forwarding (DAF) are disclosed.

Specifically, DAF addresses these technical challenges by automating the enforcement of DNS policies (e.g., DNS security policies) directly within the network data plane.

More specifically, DAF aims to enhance network security by ensuring that DNS-based policies are applied to the network data plane consistently, preventing unauthorized access to network resources. This enables DNS security policies to be policy decision points for both DNS and the network data plane for policy enforcement.

In some embodiments, a system, a process, and/or a computer program product for dynamically programming a network data plane based on DNS responses embodied in a non-transitory computer readable medium and comprising computer instructions includes: intercepting a DNS query and a DNS response using a DNS intercept and inspection component/module; analyzing DNS packets based on a DNS policy or a Response Policy Zone (RPZ) policy using the DNS intercept and inspection component/module; redirecting DNS traffic from an untrusted DNS server to a trusted DNS server using a DNS traffic redirection component/module; and enforcing a network access policy in a network data plane using a network access policy programming component/module.

In some embodiments, a system, a process, and/or a computer program product for dynamically programming a network data plane based on DNS responses embodied in a non-transitory computer readable medium and comprising computer instructions includes: intercepting a DNS query and a DNS response using a DNS intercept and inspection module of an endpoint agent executed on an endpoint; analyzing DNS packets based on a DNS policy or a Response Policy Zone (RPZ) policy using the DNS intercept and inspection module of the endpoint agent; redirecting DNS traffic from an untrusted DNS server to a trusted DNS server using a DNS traffic redirection module of the endpoint agent; and enforcing a network access policy in a network data plane using a network access policy programming module.

For example, the DNS inspection component can determine whether to allow, block, or redirect network traffic to a Fully Qualified Domain Name (FQDN) based on the DNS resolution with the trusted DNS server (e.g., trusted DNS resolver). Also, the redirection can be transparent to a DNS client associated with the DNS query.

The network access policy programming component can be configured to automatically mirror the DNS policy (e.g., DNS security policy) into the network data plane.

As such, the disclosed DAF solution, using the DNS policy and/or the RPZ policy, can implement a zero trust security policy (e.g., for an enterprise computing environment).

In this example implementation, the disclosed DAF system/service includes the DNS intercept and inspection component/module and a network data plane policy programming component/module.

In some embodiments, a system, a process, and/or a computer program product for providing DAF further includes returning a redirect IP to provide a message to a user that the DNS request was not allowed per the DNS policy or the RPZ policy.

In an example implementation, a DNS Assured Forwarding (DAF) solution is disclosed that includes a comprehensive system designed to dynamically program a network data plane based on the DNS response for a domain query. The disclosed DAF system enforces the security posture of DNS through DNS policies or Response Policy Zones (RPZ), which can, for example, allow, block, or redirect network traffic to a Fully Qualified Domain Name (FQDN) in the network data plane. As such, this prevents client access to destinations if DNS resolution does not occur, typically with a trusted DNS resolver. DAF utilizes DNS packet inspection, interception, redirection, and DNS traffic buffering in order to program the network data plane in real-time. As an example, this can include DNS traffic redirection from an untrusted DNS server to a trusted DNS server without client awareness.

In some embodiments, the DAF system/service is implemented as a network entity (e.g., one or more network devices or software-based network elements) that performs the above-described DNS intercept, inspection, and above-described processing inline to provide zero trust DNS security. For example, the network access policy programming component/module can be implemented on an inline firewall.

In some embodiments, the DAF system/service is implemented as an endpoint solution (e.g., an endpoint agent/component/module) that performs the above-described DNS intercept, inspection, and above-described processing inline to provide zero trust DNS security. For example, the network access policy programming component/module can be executed on the endpoint or on an inline firewall. In an example implementation, the DAF system/service is provided as a service edge DAF solution (e.g., using BloxOne, which is commercially available from Infoblox Inc., which is headquartered in Santa Clara, CA, or using another commercially/publicly available network-based service edge solution).

As such, the disclosed techniques for DAF facilitate a data plane enforcement of DNS security policies.

For example, the disclosed DAF techniques prevent bypassing of trusted DNS servers (e.g., trusted DNS resolvers) and enforce (transparent to the clients) the use of the trusted DNS servers (e.g., trusted DNS resolvers).

Moreover, the disclosed techniques for DAF facilitate zero trust DNS security for an enterprise computing environment (e.g., including for managed as well as unmanaged devices).

These and other embodiments and aspects of the disclosed techniques for DAF will now be further described below.

### Example System Embodiments for DNS Assured Forwarding (DAF)

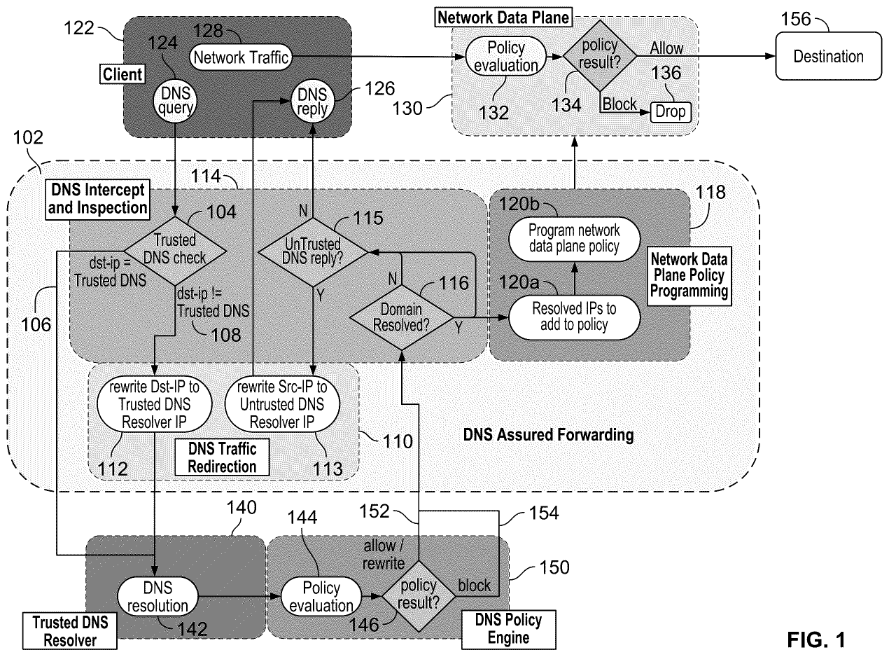

FIG. 1 is a diagram of a DNS Assured Forwarding (DAF) system in accordance with some embodiments. In an example implementation, a DNS Assured Forwarding (DAF) solution is disclosed that includes a comprehensive system designed to dynamically program a network data plane based on the DNS response for a domain query as will now be further described below.

Specifically, a DAF system 102 is disclosed as shown in FIG. 1 that dynamically programs a Network Data Plane 130 based on DNS responses. It ensures that DNS security policies are enforced by allowing, blocking, or redirecting network traffic destined to FQDNs on both DNS and Network Data Plane 130 for inline enforcement using a DNS Policy Engine 150.

More specifically, the DAF system 102 implements consistent policy actions on DNS and network data planes. The DAF system uses inline DNS packet inspection, interception, and buffering of a client's DNS traffic to achieve real-time programming of the network data plane.

Additionally, the DAF system 102 (e.g., also referred to herein as simply DAF) can redirect DNS traffic from untrusted to trusted DNS servers, such as Trusted DNS Resolver 140, without client awareness, preventing the bypass of DNS and thus facilitating consistent enforcement of DNS security policies as will be further described below.

### DAF Processing Overview

As shown in FIG. 1, if we consider DAF limited to a single domain resolution that is allowed by DNS policy to Trusted DNS Resolver 140, we can describe a simplification of the DAF system.

Suppose a Client 122 sends a DNS query 124 to a resolver for FQDN www.example.com.

DAF 102 intercepts the DNS query for www. example. com and, as shown at 104 using the DNS Intercept and Inspection module 114 of DAF 102, performs a check to determine if the destination IP in the IP header is for a Trusted DNS resolver for a list of Trusted DNS resolvers.

At 106, the destination IP (DST-IP) is determined to be a trusted DNS resolver, and as such, the DNS query is passed on to the DNS resolver, which is the Trusted DNS Resolver 140 in this example.

At 108, the DST-IP is determined to not be a trusted DNS resolver, and as such, the DNS query is passed on to a DNS Traffic Redirection component 110 (e.g., as further described below).

At 112, the DNS Traffic Redirection component rewrites the DST-IP to the Trusted DNS Resolver, which is the Trusted DNS Resolver 140 in this example, and the DNS query is then similarly passed on to the Trusted DNS Resolver 140.

At 142, the Trusted DNS Resolver 140 performs resolution of www.example.com and resolves to IP 10.10.10.10.

In addition, a check of the DNS response against its DNS policy is performed using the DNS Policy Engine 150. Specifically, as shown at 144, the DNS Policy Engine 150 performs a policy evaluation. At 146, a policy result is determined based on the policy evaluation to determine whether to allow/rewrite the DNS response as shown at 152 or to block the DNS response as shown at 154.

DAF 102 intercepts the DNS reply and inspects the response (e.g., verifying that the domain was resolved as shown at 116) for www.example.com using the DNS Intercept and Inspection module 114.

The DNS Intercept and Inspection module 114 collects the IP 10.10.10.10 in the DNS reply along with the source IP of the DNS client and sends to a Network Data Plane Policy Programming (NDDP) module 118 of DAF 102.

As shown at 120a and 120b, the NDPP module 118 then programs a policy rule on the Network Data Plane 130 to allow traffic from the DNS clients IP to the DST IP 10.10.10.10.

In this example implementation, the NDPP module 118 replies to the Intercept and Inspection module 114 that the programming was successful.

The DNS Intercept and Inspection module 114 checks if the DNS reply was from an untrusted server as shown at 115 and rewrites the SRC-IP as shown at 113, otherwise the reply is sent to the client 122 as shown at 126.

The client 122 sends Network Traffic 128 to the IP address 10.10.10.10 from its source IP.

The client's Network Traffic 128 passes through the Network Data Plane 130 that was programmed to allow the Network Traffic 128 and is allowed to communicate with IP address 10.10.10.10.

Specifically, the Network Data Plane 130 performs a policy evaluation as shown at 132 and determines the policy result at 134. If the policy result is to not allow the Network Traffic 128 to communicate with IP address 10.10.10.10, then the Network Traffic 128 is dropped as shown at 136. Otherwise, as in this example use case, the Network Traffic 128 is allowed to communicate with 10.10.10.10, and the Network Traffic 128 is allowed to communicate with a Destination 156 that is associated with the IP address 10.10.10.10 as shown in FIG. 1.

If the DNS resolution had failed as determined at 116, then the Network Data Plane 130 would not have been programed and any traffic destined to IP address 10.10.10.10 would have been blocked by the network data plane default policy.

Each of the above-described modules/components of the DAF system will now be further described below.

### DNS Intercept and Inspection Module

In an example implementation, the above-described DAF system/service includes the DNS intercept and inspection module 114 that analyzes DNS packets to determine the security posture based on DNS responses, which were generated based on the upstream resolvers DNS policies and/or Response Policy Zone (RPZ) policies.

As an example, the DNS intercept and inspection module 114 can inspect various DNS record types, including A, AAAA, Canonical Name (CNAME), MX, Service Binding (SVCB), Hypertext Transfer Protocol Secure (HTTPS), and TXT records.

In this example implementation, the inspection process includes checking the DNS query destination IP against a list of trusted DNS resolvers. The result is passed to the DNS traffic redirection module.

The IP addresses returned in a DNS response are collected to be used for policy rules to allow access for successfully resolved FQDNs.

The DNS inspection module can follow CNAME Chaining to determine an IP to be used for enforcement (e.g., as needed/desired based on a policy, such as an enterprise DNS/security policy).

Failed resolution responses, such as NXDOMAIN, NODATA, SERVFAIL, are passed to the client and no action is performed. In this example implementation, the default policy is to block all network flows that have not successfully resolved or are not included in an IP bypass-list of known trusted IP addresses or domains (e.g., the DNS policy and/or the RPZ policy implement a zero trust security policy for an enterprise).

### DNS Traffic Redirection Module

In an example implementation, the above-described DAF system/service includes the DNS Traffic Redirection module 110 that modifies the destination IP address within the IP header of DNS packets, when traffic is sent to an untrusted or unknown DNS resolver.

As an example, the DNS Traffic Redirection module 110 can redirect DNS traffic from untrusted DNS servers to trusted DNS servers without the DNS client's awareness (e.g., the redirect of the DNS traffic is transparent to the client in this example implementation).

In this example implementation, the redirection process includes rewriting the destination IP address and recalculating the IP header checksum to ensure packet integrity.

The DNS Traffic Redirection module 110 can also perform Network Address Translation (NAT) to maintain session continuity and avoid disruption to the DNS client.

### Network Data Plane Policy Programming Module

In an example implementation, the above-described DAF system/service includes the Network Data Plane Policy Programming module 118 that dynamically programs network access policies into the network data plane (130) based on the results of DNS inspection.

As an example, the Network Data Plane Policy Programming module 118 can interface with network devices, such as switches, routers, firewalls, or end-user machine firewalls to enforce access control policies.

The policies (e.g., enterprise DNS/security policies, including a DNS policy and/or an RPZ policy) can include rules for allowing, blocking, or redirecting traffic to specific FQDNs based on DNS resolution with trusted resolvers.

The Network Data Plane Policy Programming module 118 ensures that DNS security policies are mirrored into the network data plane automatically, which thereby eliminates the need for manual configuration (e.g., which is time consuming and error prone).

In this example implementation, the Network Data Plane Policy Programming module 118 can be implemented using a publicly available solution, such as Open vSwitch (OvS) (e.g., which is publicly available at https://www.openvswitch.org/ or another similar publicly/commercially available solution can similarly be used) for the data plane (e.g., programmed using a high-level programming language, such as, for example, Go and/or C++, or using other high-level programming languages).

In this example implementation, the DAF system/service is implemented as a network entity (e.g., one or more network devices or software-based network elements) that performs the above-described DNS intercept, inspection, and above-described processing inline to provide zero trust DNS security as described above with respect to FIG. 1. In this example, the DNS enforcement can be performed at a DNS firewall or other inline firewall (e.g., for an enterprise computing environment). As such, the disclosed DAF system/service can be implemented as an on-premises (on-prem) DAF system/service or as an off-premises (off-prem) DAF system/service.

In another example implementation, the DAF system/service is implemented as an endpoint solution (e.g., an endpoint agent/component/module) that similarly performs the above-described DNS intercept, inspection, and above-described processing inline to provide zero trust DNS security. For example, the DNS enforcement can be performed on the endpoint using the endpoint agent and/or at a DNS firewall or other inline firewall (e.g., for an enterprise computing environment).

As will now be apparent to one of ordinary skill in the art, the above-described DAF system can be provided as a system, which can be implemented on-premises for enterprises or as a cloud-based system/solution, and/or the above-described DAF system can be provided as a service (e.g., Software as a Service (SaaS) solution).

### Example Graphical User Interface of the DAF System

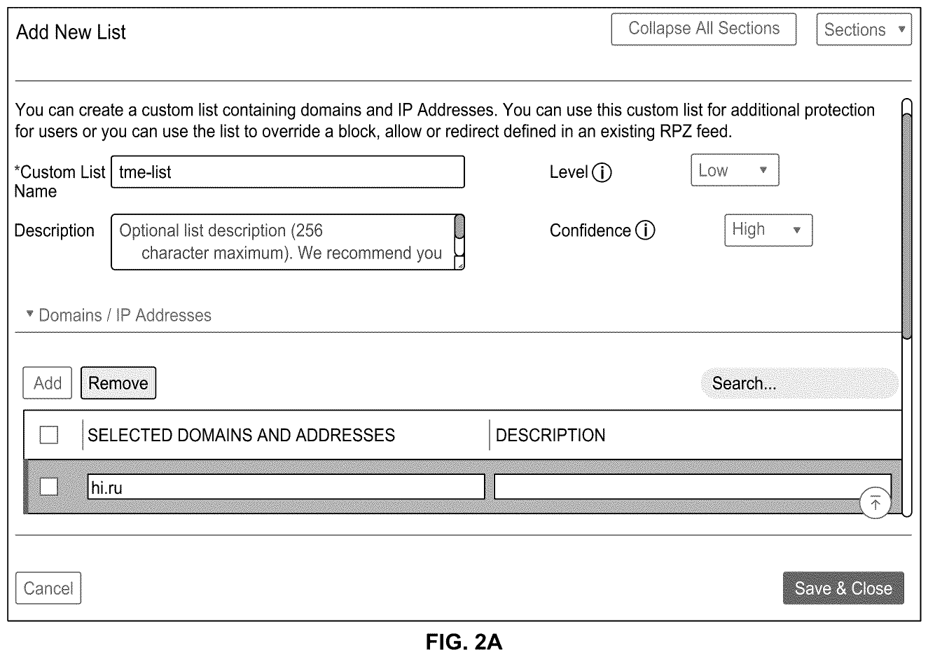

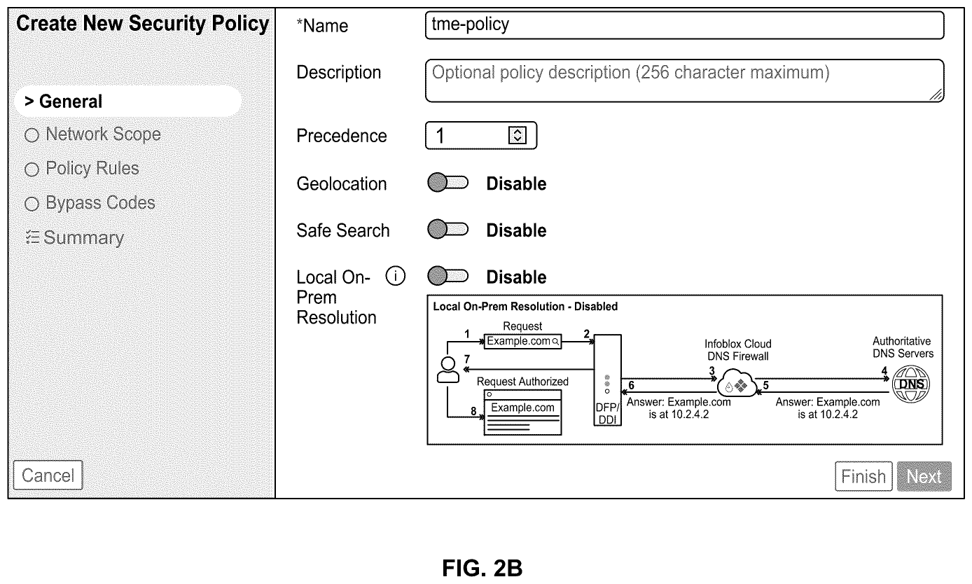

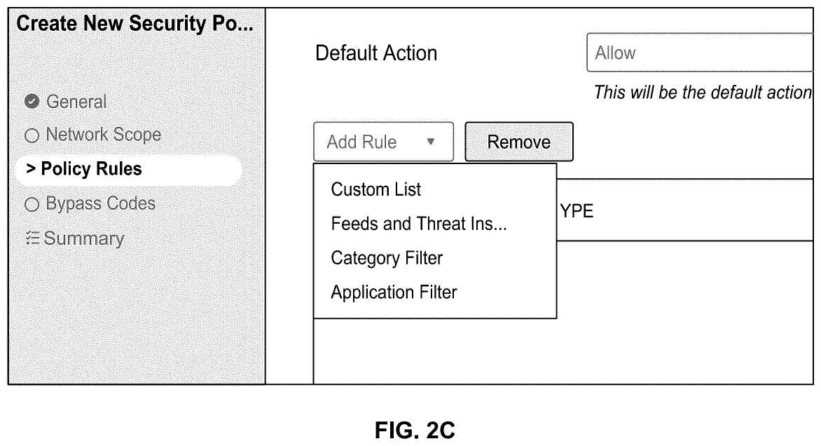

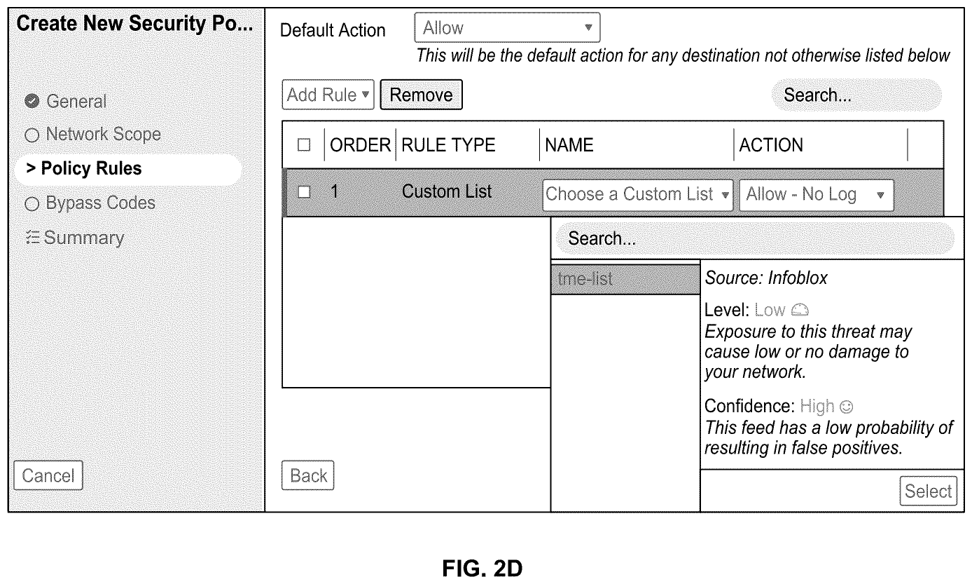

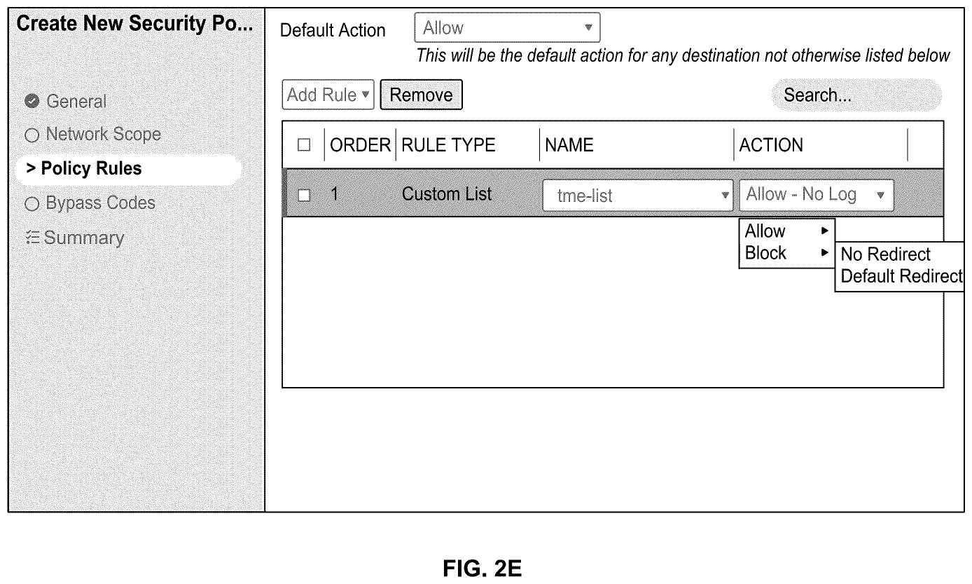

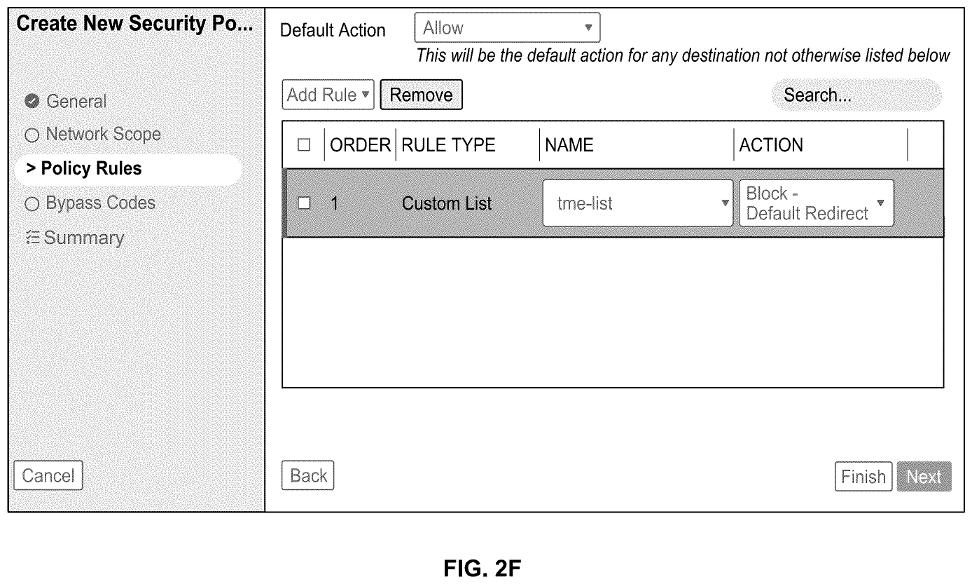

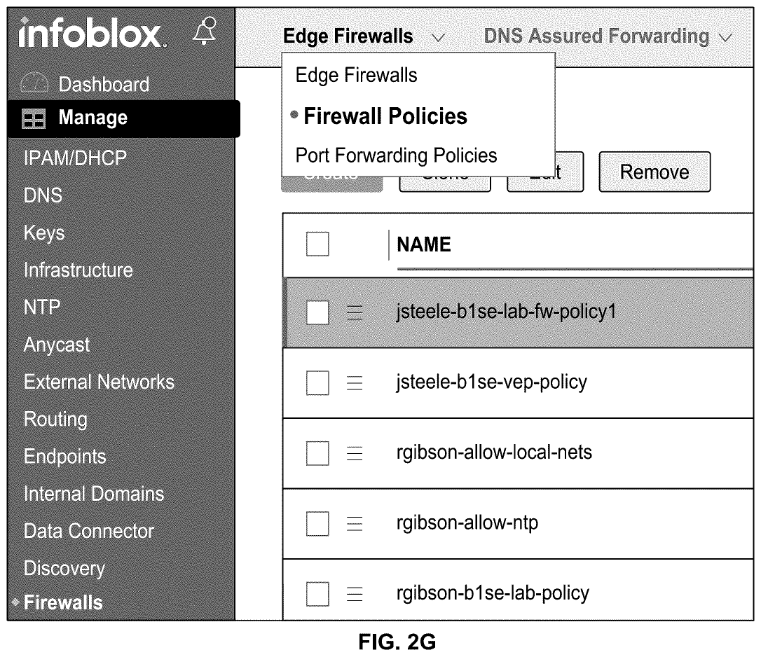

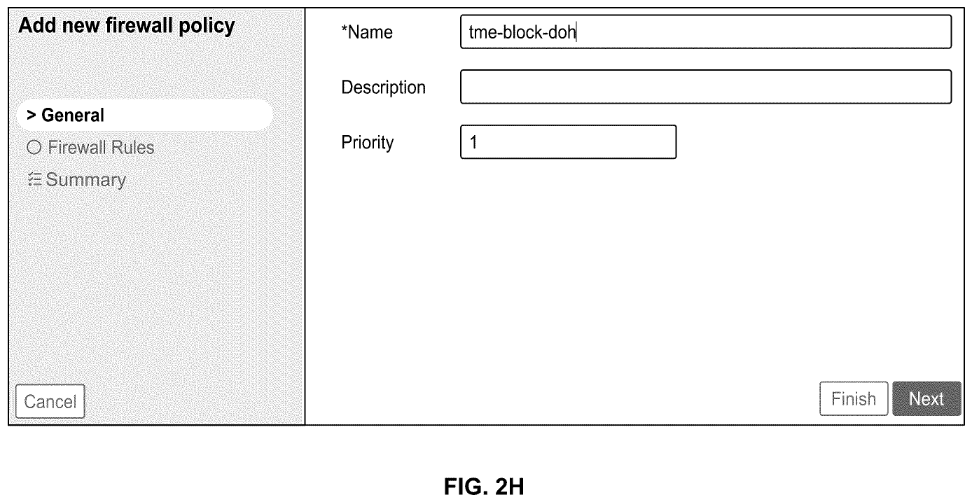

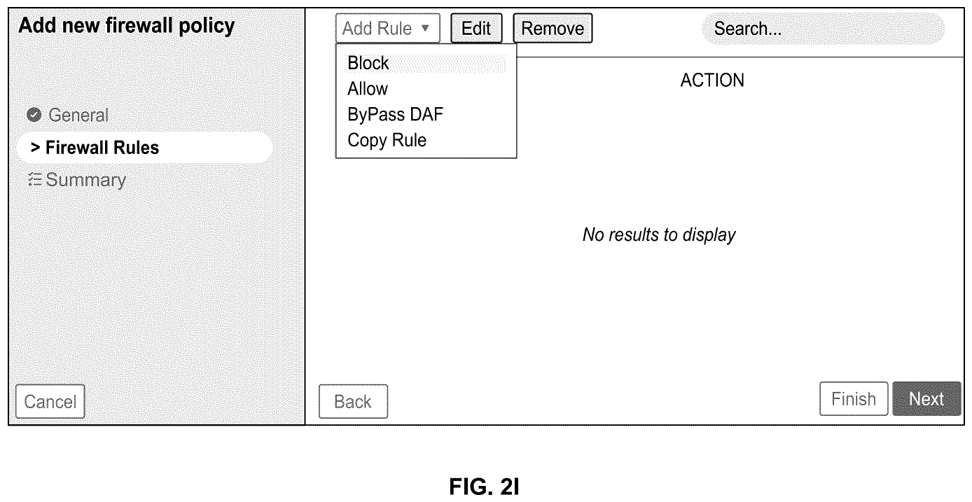

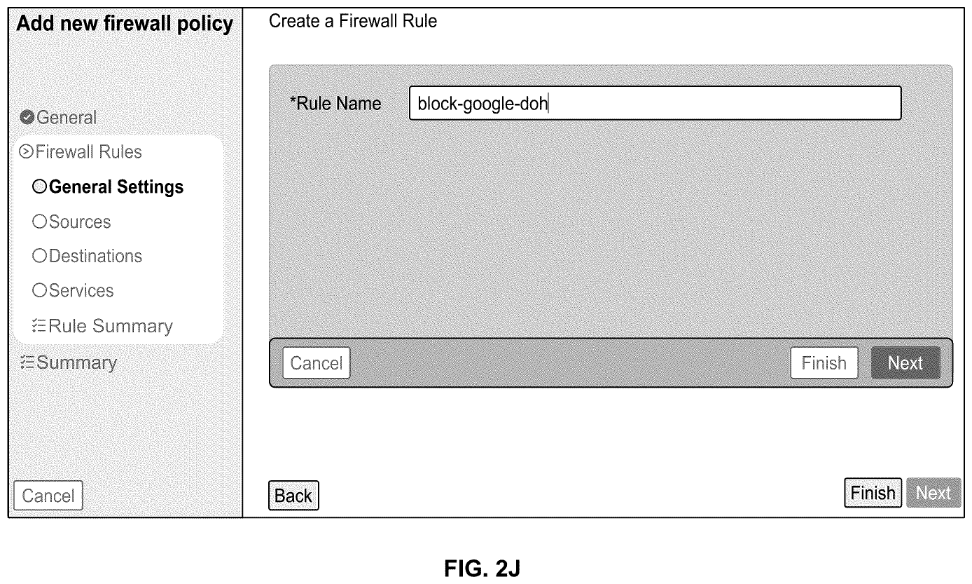

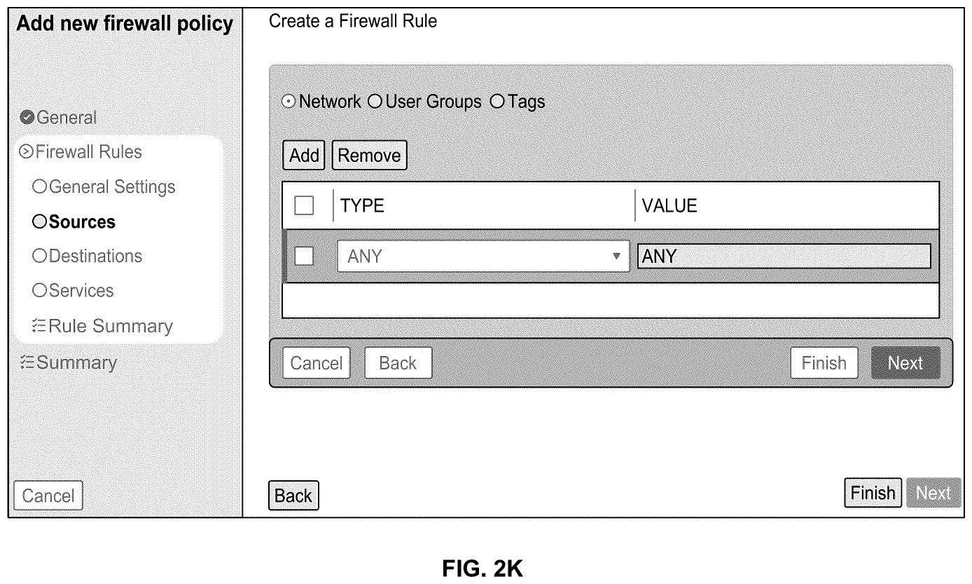

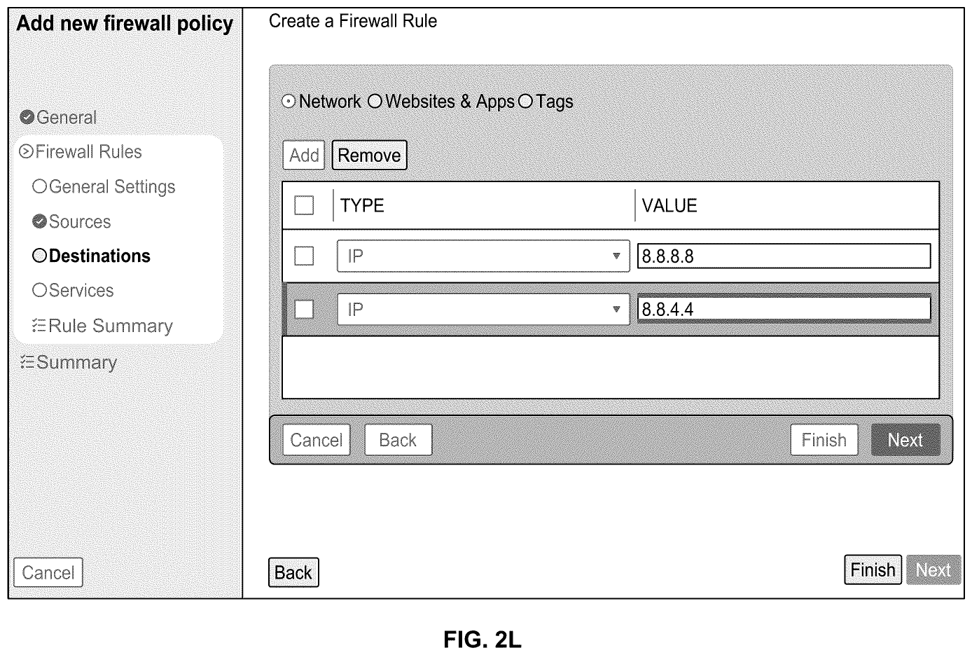

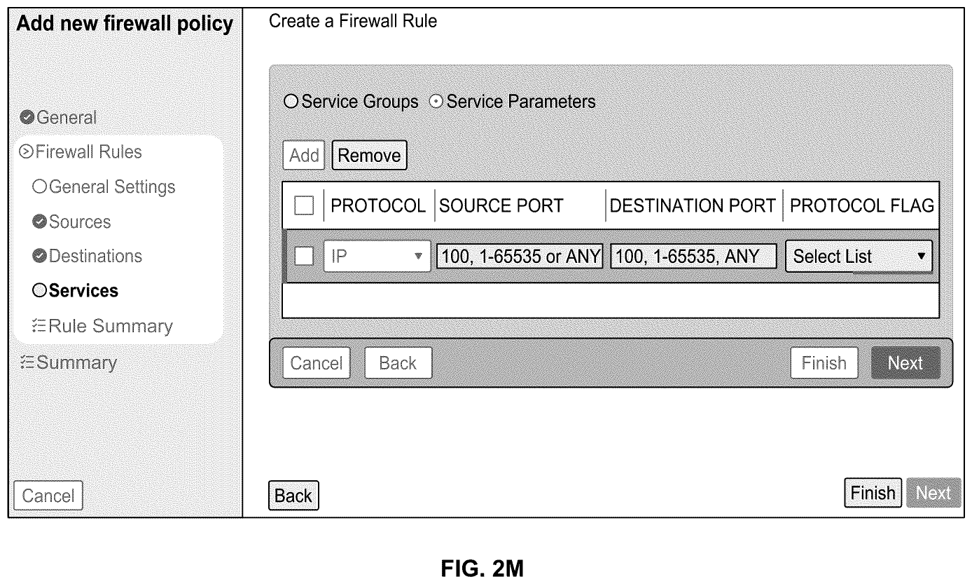

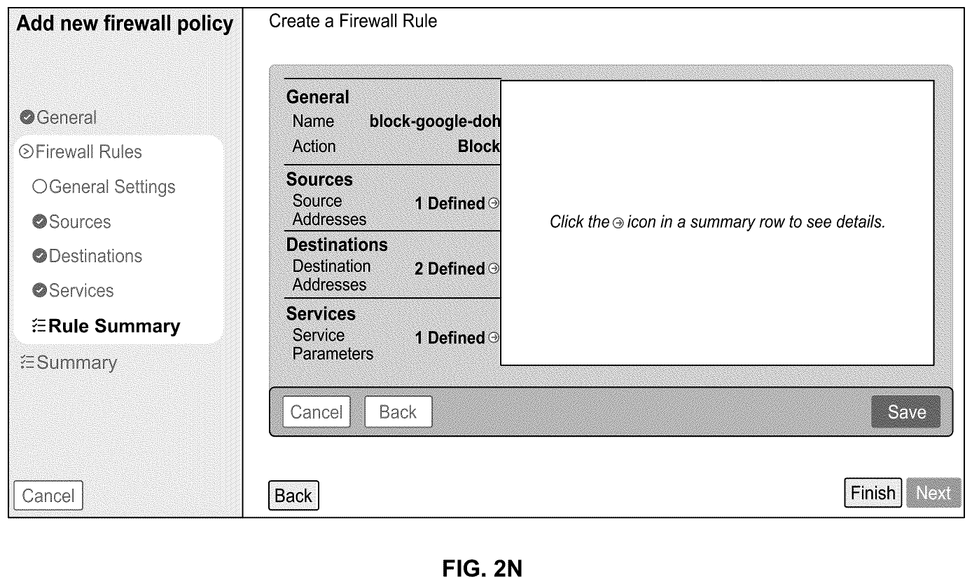

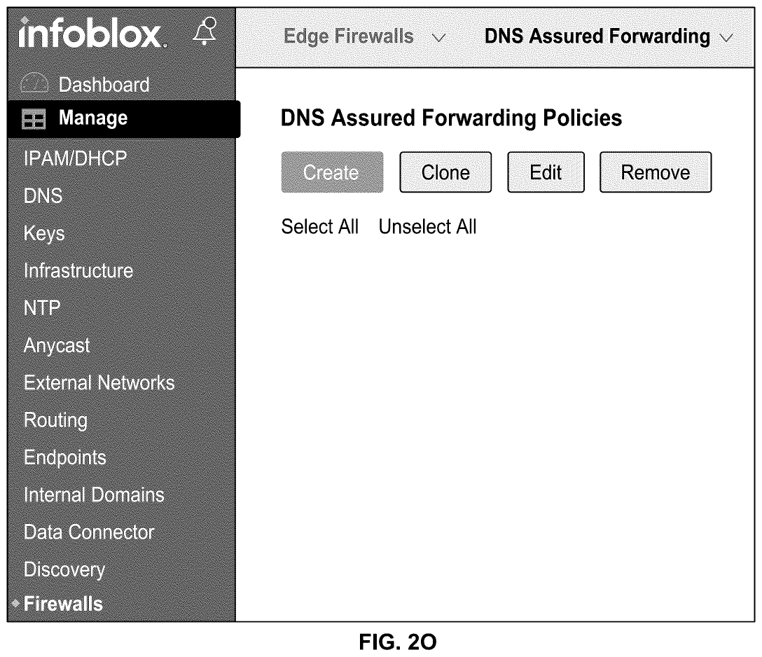

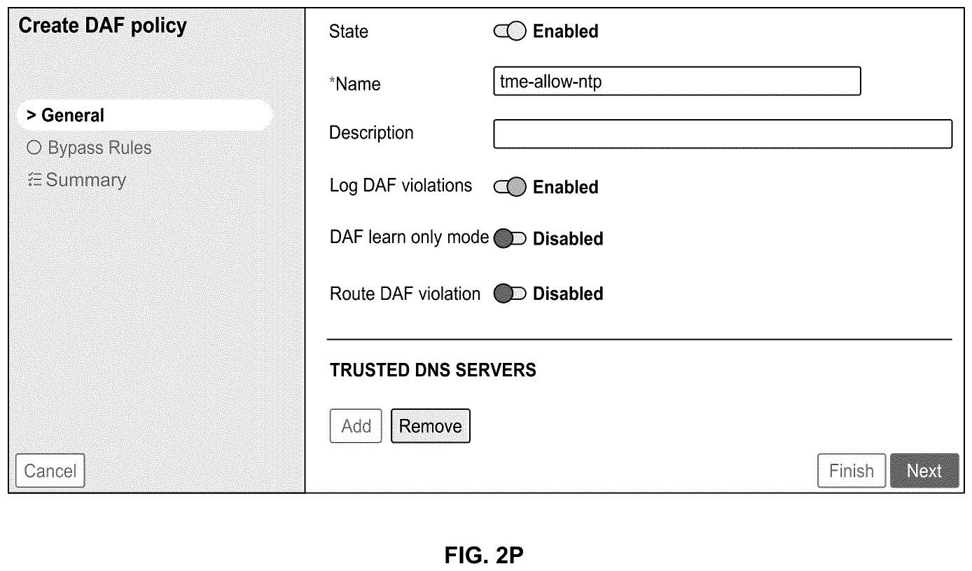

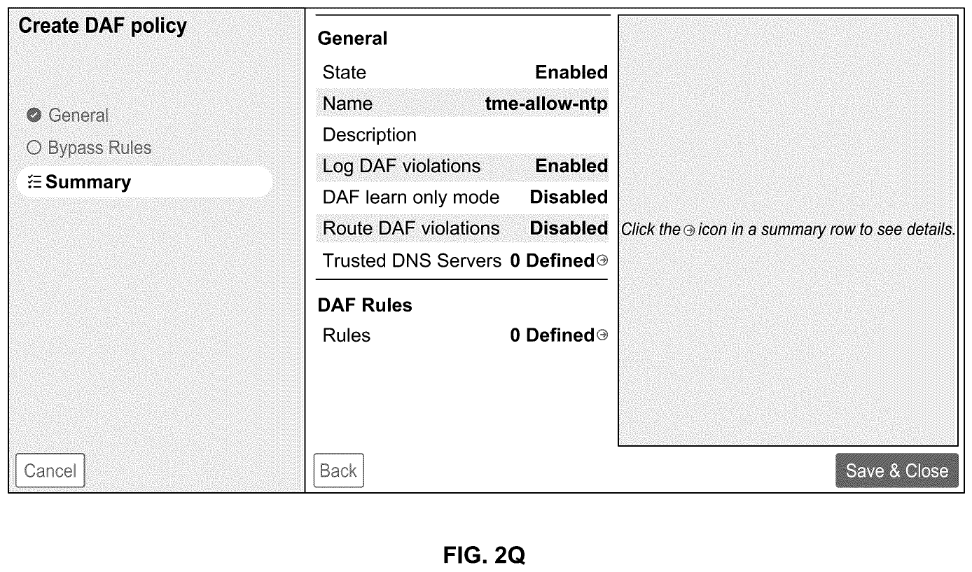

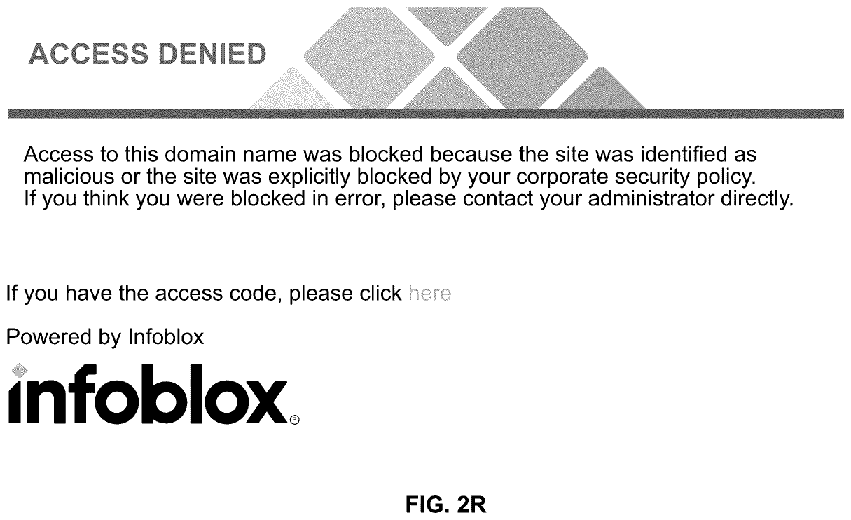

FIGS. 2A-2R are screen diagrams of graphical user interfaces of the DAF system in accordance with some embodiments.

FIG. 2A is an example screen diagram of the graphical user interface of the DAF system for adding a custom list of domains and IP addresses for additional protection for users or to be used to override a block, allow, or redirect defined in an enterprise RPZ feed, such as similarly described above with respect to FIG. 1.

FIGS. 2A-2F are example screen diagrams of the graphical user interface of the DAF system for creating a new security policy (e.g., a DNS security policy), such as similarly described above with respect to FIG. 1.

FIGS. 2G-2N are example screen diagrams of the graphical user interface of the DAF system for creating a new firewall policy, such as similarly described above with respect to FIG. 1.

FIGS. 2O-2Q are example screen diagrams of the graphical user interface of the DAF system for creating a new DAF policy, such as similarly described above with respect to FIG. 1.

FIG. 2R is an example screen diagram of the graphical user interface of the DAF system informing a user that the DNS request was denied, such as similarly described above with respect to FIG. 1.

### Example Use Cases

### Example Use Case 1: Dynamically Programming a Network Data Plane Based on DNS Responses

A network security appliance or software module (e.g., of a DAF system/service) intercepts DNS queries and responses, inspects the DNS packets to determine if they comply with predefined security policies, redirects DNS traffic from untrusted DNS servers (e.g., DNS resolvers) to trusted DNS servers (e.g., DNS resolvers), and programs network access policies into the data plane to enforce these decisions, such as similarly described above with respect to FIG. 1.

### Example Use Case 2: DNS Inspection Blocks Traffic to an Untrusted DNS Resolver

When a client device attempts to access example. com, the DNS inspection module checks if the DNS response came from a trusted resolver. If the DNS response is determined to be from a trusted resolver, then the DAF system/service allows the traffic. If the response came from an untrusted DNS resolver, then the DAF system/service blocks the traffic, such as similarly described above with respect to FIG. 1. For example, common DNS-based attacks/malware/intrusion/nefarious activities commonly exploit untrusted DNS resolvers (e.g., resolving a DNS query to a malware/nefarious associated IP address).

### Example Use Case 3: DNS Traffic Redirected to Trusted DNS Resolver

A client device sends a DNS query to an untrusted DNS server (e.g., untrusted DNS resolver). The DAF system/service intercepts this query, redirects it to a trusted DNS server (e.g., trusted DNS resolver), and returns the response to the client without the client being aware of the redirection. The client believes it received the DNS response from the original untrusted DNS server (e.g., untrusted DNS resolver), such as similarly described above with respect to FIG. 1.

### Example Use Case 4: Network Data Plane Policy Mirrors the DNS Security Policy

A DNS admin updates its DNS security policy to block access to malicious. com. The DAF system/service automatically updates the network data plane to enforce this policy when resolutions occur in real-time. This ensures that any attempt to access malicious. com is blocked at the network level without requiring manual configuration by the network admin or interactions with a different group that manages or controls that network data plane. As such, there are no delays or periods when the policies are not in sync, as the network policy data plane is updated in real-time based on DNS resolutions, such as similarly described above with respect to FIG. 1.

Example process embodiments for DAF will now be further described below.

### Example Process Embodiments for DNS Assured Forwarding (DAF)

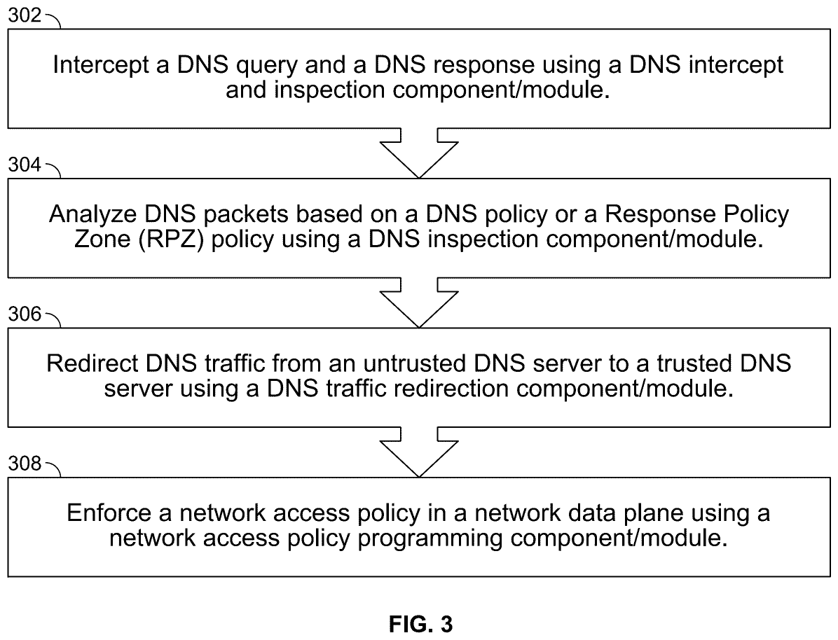

FIG. 3 is a flow diagram of a DAF process in accordance with some embodiments. In some embodiments, the process can be performed using the embodiments as similarly described above, such as with respect to FIG. 1.

At 302, intercepting a DNS query and a DNS response is performed using a DNS intercept and inspection component/module, such as similarly described above with respect to FIG. 1.

At 304, analyzing DNS packets based on a DNS policy or a Response Policy Zone (RPZ) policy is performed using a DNS inspection component/module, such as similarly described above with respect to FIG. 1.

At 306, redirecting DNS traffic from an untrusted DNS server to a trusted DNS server is performed using a DNS traffic redirection component/module, such as similarly described above with respect to FIG. 1.

At 308, enforcing a network access policy in a network data plane is performed using a network access policy programming component/module, such as similarly described above with respect to FIG. 1.

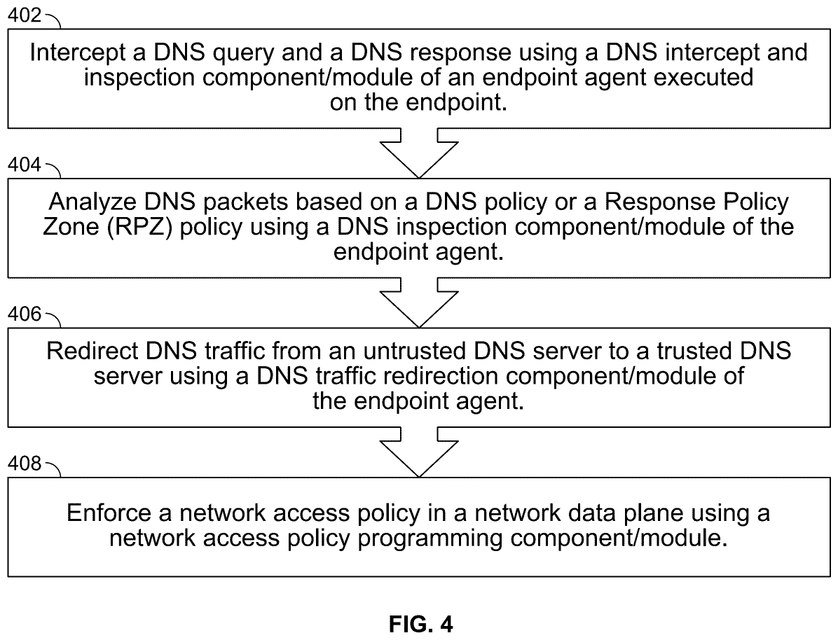

FIG. 4 is another flow diagram of a DAF process in accordance with some embodiments. In some embodiments, the process can be performed using the embodiments as similarly described above, such as with respect to FIG. 1.

At 402, intercepting a DNS query and a DNS response is performed using a DNS intercept and inspection component/module of an endpoint agent executed on the endpoint, such as similarly described above with respect to FIG. 1.

At 404, analyzing DNS packets based on a DNS policy or a Response Policy Zone (RPZ) policy is performed using a DNS inspection component/module of the endpoint agent, such as similarly described above with respect to FIG. 1.

At 406, redirecting DNS traffic from an untrusted DNS server to a trusted DNS server is performed using a DNS traffic redirection component/module of the endpoint agent, such as similarly described above with respect to FIG. 1.

At 408, enforcing a network access policy in a network data plane is performed using a network access policy programming component/module, such as similarly described above with respect to FIG. 1.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for dynamically programming a network data plane based on Domain Name System (DNS) responses, comprising:
a processor configured to:
intercept a DNS query and a DNS response using a DNS intercept and inspection component;
analyze DNS packets based on a DNS policy or a Response Policy Zone (RPZ) policy using a DNS inspection component;
redirect DNS traffic from an untrusted DNS server to a trusted DNS server using a DNS traffic redirection component; and
enforce a network access policy in the network data plane using a network access policy programming component; and
a memory coupled to the processor and configured to provide the processor with instructions.

2. The system of claim 1, wherein the DNS inspection component determines whether to allow, block, or redirect network traffic to a Fully Qualified Domain Name (FQDN) based on DNS resolution with the trusted DNS server.

3. The system of claim 1, wherein the redirection is transparent to a DNS client associated with the DNS query.

4. The system of claim 1, wherein the network access policy programming component is implemented on an inline firewall, and wherein the network access policy programming component automatically mirrors the DNS policy into the network data plane.

5. The system of claim 1, wherein the DNS policy and/or the RPZ policy implements a zero trust security policy.

6. The system of claim 1, wherein a DNS assured forwarding (DAF) system or a DAF service includes the DNS intercept and inspection component.

7. The system of claim 1, wherein a DNS assured forwarding (DAF) system or a DAF service includes the DNS intercept and inspection component and a network data plane policy programming component.

8. The system of claim 1, wherein the processor is further configured to:
return a redirect IP to provide a message to a user that a DNS request was not allowed per the DNS policy or the RPZ policy.

9. A method for dynamically programming a network data plane based on DNS responses, comprising:
intercepting a DNS query and a DNS response using a DNS intercept and inspection module;
analyzing DNS packets based on a DNS policy or a Response Policy Zone (RPZ) policy using a DNS inspection module;
redirecting DNS traffic from an untrusted DNS server to a trusted DNS server using a DNS traffic redirection module; and
enforcing a network access policy in the network data plane using a network access policy programming module.

10. The method of claim 9, wherein the DNS inspection module determines whether to allow, block, or redirect network traffic to a Fully Qualified Domain Name (FQDN) based on DNS resolution with the trusted DNS server.

11. The method of claim 9, wherein the redirection is transparent to a DNS client associated with the DNS query.

12. The method of claim 9, wherein the network access policy programming component is implemented on an inline firewall, and wherein the network access policy programming module automatically mirrors the DNS policy into the network data plane.

13. The method of claim 9, wherein the DNS policy and/or the RPZ policy implements a zero trust security policy.

14. The method of claim 9, further comprising:
returning a redirect IP to provide a message to a user that a DNS request was not allowed per the DNS policy or the RPZ policy.

15. A computer program product for dynamically programming a network data plane based on DNS responses embodied in a non-transitory computer readable medium and comprising computer instructions for:
intercepting a DNS query and a DNS response using a DNS intercept and inspection module;
analyzing DNS packets based on a DNS policy or a Response Policy Zone (RPZ) policy using a DNS inspection module;
redirecting DNS traffic from an untrusted DNS server to a trusted DNS server using a DNS traffic redirection module; and
enforcing a network access policy in the network data plane using a network access policy programming module.

16. The computer program product of claim 15, wherein the DNS inspection module determines whether to allow, block, or redirect network traffic to a Fully Qualified Domain Name (FQDN) based on DNS resolution with the trusted DNS server.

17. The computer program product of claim 15, wherein the redirection is transparent to a DNS client associated with the DNS query.

18. The computer program product of claim 15, wherein the network access policy programming component is implemented on an inline firewall, and wherein the network access policy programming module automatically mirrors the DNS policy into the network data plane.

19. The computer program product of claim 15, wherein the DNS policy and/or the RPZ policy implements a zero trust security policy.

20. The computer program product of claim 15, further comprising computer instructions for:
returning a redirect IP to provide a message to a user that a DNS request was not allowed per the DNS policy or the RPZ policy.
